(19) United States
(12) Patent Application Publication
(10) Pub. No.: US 2026/0264293 A1
(43) Pub. Date: Sep. 10, 2026

(54) METHOD FOR RECYCLING POLYOLEFIN CONTAINERS

(71) Applicant: ALPLA WERKE ALWIN LEHNER GMBH & CO. KG, Hard (AT)

(72) Inventor: Michael HEYDE, Bergisch Gladbach (DE)

(21) Appl. No.: 19/167,470

(22) PCT Filed: Mar. 21, 2024
(86) PCT No.: PCT/EP2024/057639

§ 371 Date: Sep. 22, 2025

(30) Foreign Application Priority Data
Mar. 24, 2023 (CH) CH000328/2023

(51) Int. Cl. B29B 17/02; B29B 17/04; B29K 23/00

(52) U.S. Cl. CPC B29B 17/02; B29B 17/0412; B29B 2017/0241; B29B 2017/0289; B29B 2017/0468; B29K 2023/00

(57) ABSTRACT

A method for recycling polyolefin containers, includes (a) sorting the containers, (b) crushing the containers to flakes, (c) a washing step, (d) air separation, (e) sorting the flakes, (f) granulating the flakes in an extruder, and (g) odor treatment of the granular material. The washing step (c) is carried out with a lye having a lye temperature of less than 60° C. and a lye concentration of less than 0.5 wt. %.

### FIELD OF THE INVENTION

The invention relates to a method for recycling polyolefin containers in accordance with the preamble of claim 1.

### PRIOR ART

A treatment method for producing polyolefin recyclates is known from the prior art in which polyolefin-containing residues are crushed into flakes. The flakes are subjected to washing in an alkaline medium, sorting, and granulation and degassing in an extruder. The resulting granular material can be used to produce new consumer product packaging.

The washing is carried out with water at 80° C. (hot wash) and with a lye concentration of 1 to 3 wt. %. The advantage of these washing conditions is that the flakes are reliably freed from impurities, label residues and adhesive residues. However, these washing conditions also have disadvantages:

Polyolefins, especially HDPE (high density polyethylene) and PP (polypropylene), are non-polar polymers. During recycling, these are washed with polar media such as water, lyes and acids. Washing lyes are widely used. Washing non-polar plastics materials with a polar washing lye has the immediate consequence that impurities that are less polar than water or sodium hydroxide solution dissolve more in the polymer and thus contaminate the polymer. These impurities can cause unpleasant odors and discoloration. These impurities can also contaminate food placed in a recycled container or cause skin irritation when the container is touched. Although washing cleans the surface of the flakes, the material itself becomes further contaminated by washing.

Before washing in the recycling plant, there are substances on the polyolefin flakes to be washed that can only be removed by chemical degradation in the context of an etching reaction. This etching can be carried out using lyes or acids. Lyes are commonly used, mostly 1 to 3% sodium hydroxide solution, because they are inexpensive to produce. Large molecules that do not penetrate the polyolefin matrix due to their size are severely degraded by lyes. This creates small molecules that penetrate deep into the matrix and thereby contaminate the polymer. Here, too, contamination occurs in the polymer matrix, as described in the last paragraph. The higher the temperature of the washing lye, the better the surfaces of the flakes are etched by the lye, but the higher the impurity concentration in the polymer matrix.

On the polyolefins there are adhesives, labels and sleeves with colors, coatings and other types of decoration that detach well or better from the polyolefins at elevated temperatures. These residues partly cross-link further due to the hot wash or release softeners and therefore become brittle due to the hot wash. It is difficult to separate the resulting dust particles (fines) using optical separation mechanisms. Sleeves made of PETG or other polyesters such as PLA roll up when washed in hot water and enclose the polyolefin flakes by wrapping and rolling them up. Separation using the sink-float method is there-fore often no longer possible. Polyester particles to be sorted out reach their glass transition point at temperatures above 60° C., become sticky and adhere to the equipment of the recycling plant. Separation of the sticky polyester particles is made difficult by their adhesion.

### OBJECT OF THE INVENTION

The disadvantages of the described prior art give rise to the object of creating an improved treatment method in which the quality of the cleaned polyolefin flakes, in particular their polymer matrix contamination with impurities and their surface contamination with label and adhesive residues, is improved.

### DESCRIPTION

In a method for recycling polyolefin containers, the stated object is achieved by the features listed in the characterizing section of claim 1. The dependent claims relate to developments and/or advantageous alternative embodiments.

The invention is characterized in that the washing step is carried out with a lye having a lye temperature of less than 60° C. and a lye concentration of less than 0.5 wt. %. The flakes, which are still cold after the cold washing, pick up fewer impurities since the material is still cold in the interior, and the migration of odorous substances into the material is significantly lower in a cold state. Due to the low lye concentration, large molecules of impurities that are on the surface of the flakes (e.g. adhesive residues) are less degraded. The unwanted migration of small molecules into the polymer matrix is thus significantly reduced.

The “mild” lye parameters surprisingly lead to a significant improvement in product quality with regard to odor pollution, discoloration, and irritation upon skin contact: by lowering the temperature, the usual contaminations of polyolefins in the concentration of butyric acid, nonenal, nonanal, nonalactone, and limonene can be reduced by 50%. By further reducing the lye concentration, the migrated contamination is reduced by a further 10 to 20%.

In a preferred embodiment of the invention, the lye has a temperature between 40° C. and 60° C. At this low temperature range, the tendency of small molecules to migrate into the polyolefin matrix is significantly reduced. The cleaning performance of the lye is still sufficient above 40° C., since flakes to which label and adhesive residues still adhere after the washing step can be detected and separated in a flake sorting system.

It is preferred if, in the washing step, the lye is treated and cleaned in a lye treatment and the washing step is carried out partly with fresh lye and partly with lye treated in the lye treatment. As a result, there are fewer dissolved impurities in the lye that could undesirably migrate into the polyolefin matrix. The purity of the lye therefore improves the quality of the flakes in terms of odor pollution.

It has proven advantageous if the crushing is a wet crushing using washing water and acts as a first washing step, the washing water being treated in a water treatment. This means that at the same time as the containers are shredded into flakes, a rough cleaning of the containers and the flakes takes place.

Advantageously, the washing step is a second washing step, whereby the flakes are cleaned twice, namely during the wet crushing and during the washing step.

In a further preferred embodiment of the invention, the lye is fed to the crushing process in countercurrent after the lye treatment. Countercurrent flow of the lye without prior treatment is economically problematic. The lye is there-fore regenerated in the lye treatment and kept in circulation for as long as possible. By partially feeding the regenerated lye into the crushing process, the cleaning performance of the washing water is increased.

In a further preferred embodiment of the invention, sorting the flakes is an optical sorting with color recognition and/or polymer recognition. Surprisingly, the sorter detects label and adhesive residues because contaminated flakes of this kind have a different color and/or a different polymer than the flakes that are not sorted out by the sorter.

In a further particularly preferred embodiment of the invention, flakes with label residues and adhesive residues are sorted out when sorting the flakes. Due to the selected parameters of the washing lye regarding temperature and concentration, more label, film and adhesive residues remain on the flakes than if the lye parameters according to the prior art were 80° C. and had a lye concentration of at least 1%. The flakes with residual contamination can be separated very well by sorting the flakes, which can completely compensate for the disadvantage of washing with cold and mild lye.

Further advantages and features will become apparent from the following description of an embodiment of the invention with reference to a schematic flow chart representation.

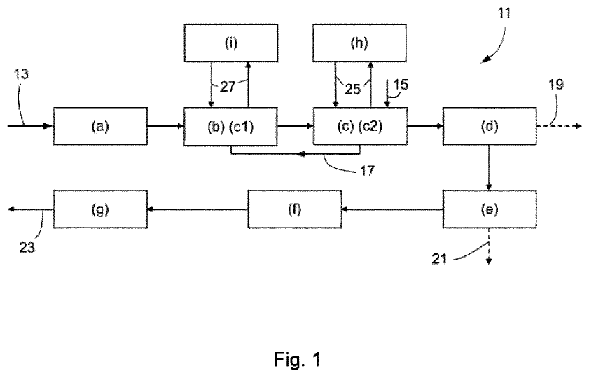

FIG. 1 is a flow chart of a method according to the invention for recycling polyolefin containers which originate from collected post-consumer waste, which method is denoted overall by the reference sign 11. The method is used to produce PCR (post-consumer recycled) granular material, which in turn can be used to produce recycled polyolefin containers. This requires higher requirements for characteristics such as particle contamination, color and odor than when the granular material is used to manufacture products in the construction industry, such as sewage pipes.

The flow chart of the method for recycling polyolefin containers shows the method steps (a) to (g) in a given order. In a first method step (a), the disposed and collected polyolefin containers 13 (input material) are sorted. The containers are sorted by color and polymer. This allows other polymers that are still present in the polyolefin recycling stream to be sorted out and different color classes to be created.

In step (b), the containers are crushed to flakes in a wet cutting mill with a water circulation 27 including water treatment (i) and the flakes are fed to a washing step (c). The increased quality requirements regarding granular material contamination, odor and color can surprisingly be realized with a lye 15 having a lye temperature of less than 60° C. and particularly preferably between less than 60° C. and 40° C. The lye concentration is less than 0.5% to minimize the degradation of large molecules as far as possible. Contrary to the general belief that only a hot wash with a 2% lye at 80° C. leads to the desired granular material quality, the required quality can also be achieved with the existing “mild” lye parameters.

The low lye temperature and the low lye concentration prevent degradation products that are harmful to quality (large molecules are degraded less) and reduce the tendency of impurities to migrate into the polyolefin matrix. The washing step (c) is carried out partly with fresh lye 15 and partly with lye 24 treated in the lye treatment (k) so that no degradation products or impurities can penetrate into the flakes. However, these washing conditions lead to an increased amount of label and film residues and adhesive residues adhering to the flakes after the washing step (c). The washing step (c) also includes a sink-float separation including final rinsing of the lye residues.

Part of the used lye is fed in countercurrent 17 to the wet crushing (b), which is carried out with >5 m³ of circulating water per megaton of plastics material waste. The crushing thus acts as a first washing step which efficiently separates coarse impurities. The circulating water 27 is to be treated using suitable process technology (i), preferably using a sedimentation tank having an upstream grit trap, before it is returned to the water circulation 27 of the crusher.

The flake stream is freed from residues 19 of free labels, tags and films (sleeves) in air separation (d). In air separation (d) the flakes can also be dried.

In sorting the flakes (e), a highly sensitive sorter is used which has color recognition and/or polymer recognition. The sorter separates the flakes 21 with a color different from the main color and flakes made of foreign polymers. Surprisingly, flakes with label and film residues and adhesive residues can also be sorted out when sorting the flakes (e), as these have a different color or a foreign polymer, which the sorter detects.

The flakes washed with low-concentration, low-temperature lye and optically sorted exhibit surprisingly high quality with regard to unwanted migration into the polymer matrix and surface impurities. In an extrusion (f) the flakes are extruded into pellets or granular material. Degassing of the recycled polyolefin material can also take place in the extruder, as it is melted and the heating can be used to separate migrated impurities. In a final step (g), the odor treatment of the granular material or the pellets takes place. The final granular material 23, which leaves the odor treatment (g), can be packed in big-backs or temporarily stored in silos.

### LIST OF REFERENCE SIGNS

11 method for recycling polyolefin containers
13 collected polyolefin containers
15 lye
17 countercurrent
19 residues of labels and films
21 flakes with different colors and polymers
23 final granular material
25 lye circulation
27 washing water circulation crusher
a color sorting of containers
b crushing the containers to flakes
c hot washing step of the flakes including float-sink separation
c1 first washing step
c2 second washing step
d air separation
e sorting the flakes
f extrusion
g odor treatment
h lye treatment
I water treatment crusher

1.-8. (canceled)

9. A method for recycling polyolefin containers, comprising:
(a) sorting the polyolefin containers,
(b) crushing the polyolefin containers to flakes,
(c) washing the flaked polyolefin,
(d) freeing the flaked polyolefin from residues by air separation,
(e) sorting the flaked polyolefin,
(f) granulating the flaked polyolefin in an extruder, and
(g) odor treating the granulated polyolefin,
wherein
the washing is carried out with a lye having a lye temperature of less than 60° C. and a lye concentration of less than 0.5 wt. %.

10. The method according to claim 9, wherein the lye has a temperature between 40° C. and 60° C.

11. The method according to claim 9, wherein in the washing the lye is treated and cleaned in a lye treatment and the washing is carried out partly with fresh lye and partly with lye treated in the lye treatment.

12. The method according to claim 9, wherein the crushing is a wet crushing using washing water and acts as a first washing step, the washing water being treated in a water treatment.

13. The method according to claim 12, wherein the washing is a second washing step.

14. The method according to claim 11, wherein the lye is fed during the crushing in countercurrent after the lye treatment.

15. The method according to claim 9, wherein sorting the flaked polyolefin comprises optical sorting comprising color recognition and/or polymer recognition.

16. The method according to claim 15, wherein when sorting the flaked polyolefin, polyolefin flakes with label residues and adhesive residues are sorted out.
